(19) United States
(12) Patent Application Publication
(10) Pub. No.: US 2005/0053411 A1
(43) Pub. Date: Mar. 10, 2005

(54) Pencil cap

(76) Inventors: John Maldonado, Venice, CA (US); Victoria Wood, Venice, CA (US)

Correspondence Address: Christopher J. McDonald;HOFFMAN, WASSON & GITLER, P.C., Suite 522, 2461 South Clark Street, Arlington, VA, 22202, US

(21) Appl. No.: 10/937,579

(22) Filed: Sep. 10, 2004

Related U.S. Application Data
(60) Provisional application No. 60/501,422, filed on Sep. 10, 2003.

(51) Int. Cl. B43K 25/00

(52) U.S. Cl. 401/52

(57) ABSTRACT

The pencil cap has a cylindrical opening for retaining the sharpened end of a pencil, such as a cosmetic pencil. The internal surface of the cap has a retainer for gripping the exterior surface of the pencil. A retainer may be threads or radially inwardly extending ribs. The cap may be for a single pencil or multiple pencils, each pencil received into a cylindrical bore formed into the cap.

This application claims the benefit of U.S. Provisional Patent Application Ser. No. 60/501,422, filed Sep. 10, 2003.

### BACKGROUND OF THE INVENTION

Cosmetic pencils are used by women to apply make-up. To this end, it is common to carry a cosmetic pencil in a purse or hand-bag to be used wherever needed. In order to be used, the pencil must be sharpened and care must be taken not to break the pencil during transport.

One way to protect the pencil end from breakage is to cover the pencil. The pencil may be covered by being placed in a case or a cap may be placed on a pencil end. Cases are large and bulky taking up more space than needed. Pencil caps are smaller and effective in protecting the pencil tip, but must be secured to the pencil. If not properly secured, the cap will fall off the pencil leaving the pencil susceptible to damage.

It is an object of the invention to provide a pencil cap that is secured to a pencil.

It is another object of the invention to provide a pencil cap that protects a pencil from damage.

It is another object of the invention to provide a pencil cap which may retain a plurality of pencils.

It is another object of the invention to provide a pencil cap which is reusable and resistant to damage.

These and other objects of the invention will become apparent to one of ordinary skill in the art after reading the disclosure of the invention.

### SUMMARY OF THE INVENTION

The pencil cap has a cylindrical opening for retaining the sharpened end of a pencil, such as a cosmetic pencil. The internal surface of the cap has a retainer for gripping the exterior surface of the pencil. A retainer may be threads or radially inwardly extending ribs. The cap may be for a single pencil or multiple pencils, each pencil received into a cylindrical bore formed in the cap.

### BRIEF DESCRIPTION OF THE DRAWINGS

FIG. 1 is a side view of the pencil cap with internal features shown in phantom;

FIG. 2 is a view of a cap holding a pencil;

FIG. 3 is a perspective view of a cap for holding a plurality of pencils;

FIG. 4 is a perspective view of an alternative embodiment of the cap; and

FIG. 5 is a bottom view of the cap of FIG. 4 for a plurality of pencils.

### DETAILED DESCRIPTION OF THE INVENTION

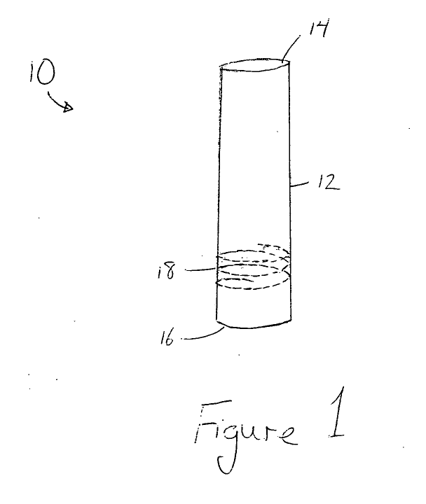

FIG. 1 shows a cap 10 formed by a cylindrical side wall 12, a circular end wall 14 and having an open bottom 16. The inner diameter of the cap 10 is slightly larger than the diameter of the pencil to be retained. Threads 18 formed on and extend from the inner surface of the cylindrical bore of the cap to engage and retain the pencil.

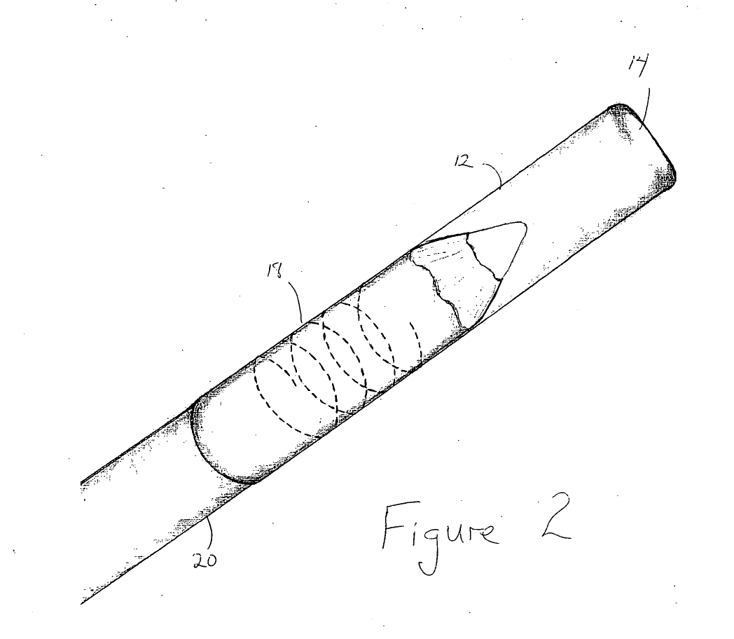

The interaction between the pencil 20 and cap 10 is shown in FIG. 2. As can be seen, the pencil is placed within the cap to an extent where the threads 18 engage the side of the pencil, yet the sharped end of the pencil does not contact the end wall 14 of the cap. The cap is made of a resilient, durable material. The benefits of such a material are two-fold. The resiliency allows a tight fit to be achieved between the pencil and cap to securely retain the pencil. Also, by not being brittle, the cap is less susceptible to cracks and breakage over an extended period of time.

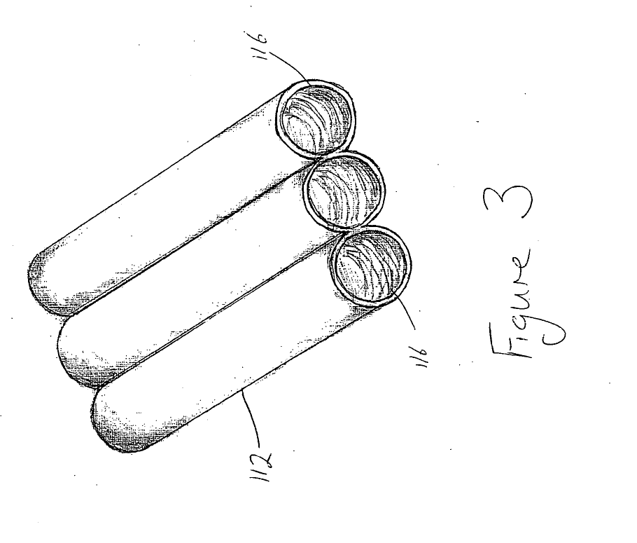

FIG. 3 shows a cap for holding a plurality of pencils. The cap may be made to hold any number of pencils, with a cap for holding three pencils illustrated. The cap has a sidewall 112 formed by a plurality of tangentially connected cylinders, for example three. Each cylinder has an open bottom 116 for allowing the insertion and retention of a pencil. Similar to the embodiment shown in FIGS. 1 and 2, the internal bore of the retainer has threads for engaging a pencil.

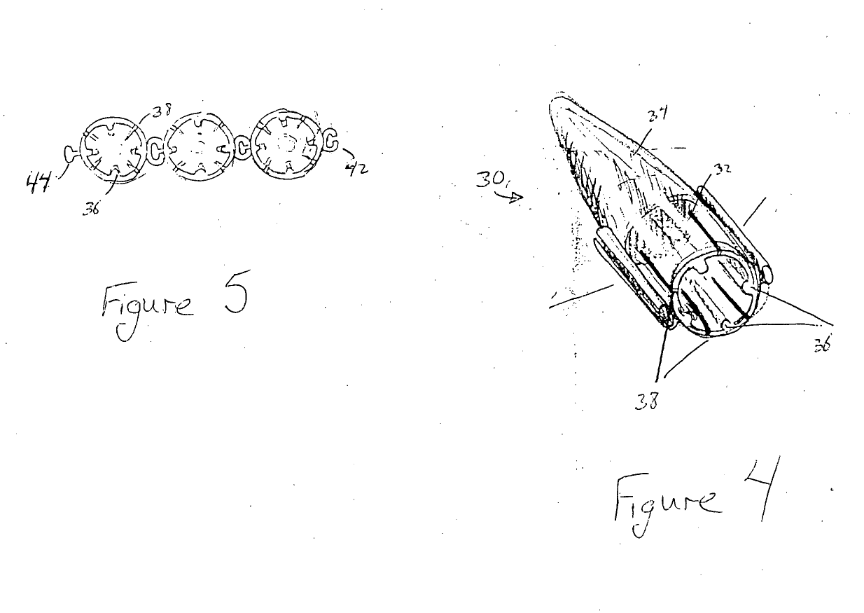

FIG. 4 shows an alternative embodiment of the retainer cap 30 having a sidewall comprised of a cylindrical portion 32 having an open bottom and a conical portion 34. The inner surface of the cap is provided with axially extending ribs 36 engaging and retaining a pencil and expansion slits 38 extending upwardly from the bottom edge of the cylindrical portion 32. The expansion slits allow an increasing diameter of the cap to accommodate the pencil. The cap is also provided with a female interlocking member 42, such as a groove, and a male interlocking member 44, such as a rib. The male and female interlocking members allow several caps to be connected to one another. Such an arrangement is shown in FIG. 5, where three caps are shown connected to one another, although any number of caps may be connected in series. This bottom view shows how the male and female interlocking members connect to hold the caps to one another.

While the invention has been described with reference to preferred embodiments, variations and modifications would be apparent to one of ordinary skill in the art. The invention covers such variations and modifications which do not depart from the scope of the invention.

1. A pencil cap, comprising
a sidewall,
a top wall connected to said sidewall, said sidewall forming at least one cylindrical bore having an internal surface, and
means for retaining a pencil formed on said internal surface.

2. The pencil cap of claim 1, wherein
said sidewall forms a plurality of cylindrical bores.

3. The pencil cap of claim 2, wherein
said plurality is three.

4. The pencil cap of claim 1, wherein
said means for retaining a pencil comprises threads.

5. The pencil cap of claim 1, wherein
said means for retaining a pencil comprises axially extending ribs.

6. The pencil cap of claim 5, further comprising
expansion slits formed in said sidewall, said slits extending upward from the bottom of said sidewall.

7. The pencil cap of claim 5, further comprising
male and female interlocking members extending from said sidewall.

8. The pencil cap of claim 7, wherein
said male and female interlocking members are rib and groove.
